(19) United States
(12) Patent Application Publication
(10) Pub. No.: US 2018/0027207 A1
(43) Pub. Date: Jan. 25, 2018

(54) CABLE WITH POWER AVERAGING CIRCUITRY

(71) Applicant: Brian Jeffrey Wengreen, Ravensdale, WA (US)

(72) Inventor: Brian Jeffrey Wengreen, Ravensdale, WA (US)

(21) Appl. No.: 15/721,482

(22) Filed: Sep. 29, 2017

Related U.S. Application Data
(63) Continuation of application No. 14/799,380, filed on Jul. 14, 2015.
(60) Provisional application No. 62/159,202, filed on May 8, 2015.

(51) Int. Cl. H04N 5/63; H02M 3/04; H02J 1/14

(52) U.S. Cl. CPC H04N 5/63; H02M 3/04; H02J 1/14

(57) ABSTRACT

A power system for a streaming media player can have a cable having a first end and a second end that is opposite the first end. The first end of the cable can be arranged and configured to receive power from a power limited USB power source. The power system can also include an electronic circuit electrically coupled to the cable. The electronic circuit can include a supercapacitor arranged and configured to store at least a portion of the power from the USB power source when power demanded by the streaming media player is less than available power from the USB power source and then release at least a portion of stored power when the power demanded by the streaming media player exceeds the available power from the USB power source.

### CROSS-REFERENCE TO RELATED APPLICATIONS

This application claims the benefit of and is a continuation of U.S. Non-Provisional patent application Ser. No. 14/799,380; filed Jul. 14, 2015; and entitled CABLE WITH POWER AVERAGING CIRCUITRY. The entire contents of U.S. patent application Ser. No. 14/799,380 are incorporated by reference herein.

U.S. Non-Provisional patent application Ser. No. 14/799,380 claims the benefit of U.S. Provisional Patent Application No. 62/159,202; filed May 8, 2015; and entitled POWER SYSTEMS FOR ELECTRONIC DEVICES. The entire contents of Patent Application No. 62/159,202 are incorporated by reference herein.

### BACKGROUND

### Field

Various embodiments disclosed herein relate to power cables. Certain embodiments relate to power cables for electronic devices, such as streaming media players, televisions, game consoles, and the like.

### Description of Related Art

Streaming media players are home entertainment electronic devices that can connect to wi-fi networks to stream digital media content to televisions. During use, streaming media players can be powered by an AC wall outlet.

A drawback of conventional streaming media players power cables is that they often require a wall outlet to be located adjacent the streaming media player. Installing a wall outlet is burdensome because it can require significant time and expense. Thus, there appears to be a need to provide a power source nearby the streaming media player.

### SUMMARY

This disclosure includes a power system for a streaming media player. The power system can include a cable having a first end and a second end that is opposite the first end, wherein the first end of the cable is configured to receive power from a power limited USB power source; and an electronic circuit electrically coupled to the cable, wherein the electronic circuit includes a supercapacitor that stores at least a portion of the power from the USB power source when power demanded by the streaming media player is less than available power from the USB power source and then releases at least a portion of stored power when the power demanded by the streaming media player exceeds the available power from the USB power source, and wherein the second end of the cable is configured to transfer at least a portion of the power from the supercapacitor to the streaming media player. In embodiments, the streaming media player is a box-type streaming media player. As well, in embodiments, the streaming media player is a stick-type streaming media player.

In embodiments, the electronic circuit comprises a current limiter that limits current to the supercapacitor. As well, the power system can include the power limited USB power source located on a television, wherein the first end of the cable is electrically and mechanically coupled to the power limited USB power source.

Even still, in embodiments, the power system can include the streaming media player, wherein the second end of the cable is electrically and mechanically coupled to the streaming media player. The streaming media player can comprise a load circuit that requires input peak power greater than 3 watts during operation.

In embodiments, the power system can include a voltage regulator electrically coupled between the supercapacitor and the cable. As well, in embodiments, the power system can include a housing having an internal space, wherein the current limiter, supercapacitor, and voltage regulator are located along the internal space of the housing.

The supercapacitor can deliver at least 3 watts power to the streaming media player for a period of time when the power limited USB power source is incapable of supplying sufficient power to the streaming media player, wherein the period of time comprises between 40 milliseconds and 5 seconds.

In embodiments, the power from the USB power source can be greater than or equal to the power demanded by the streaming media player. As well, in embodiments, peak power demanded by the streaming media player can be greater than or equal to the power from the USB power source.

As well, in embodiments, the first end of the cable can comprise a first USB type connector and the second end of the cable can comprise one of a second USB type connector and a DC plug connector. In some embodiments, the first USB type connector comprises a USB A—male connector and the second USB type connector comprises a straight micro B—male connector, wherein the second end of the cable comprises the straight micro B—male connector.

The disclosure also includes a method of providing power to a streaming media player. Methods can include electrically and mechanically coupling a first end of a power cable to a power limited USB power source located on a television; electrically and mechanically coupling a second end of the power cable to the streaming media player, wherein the second end is opposite the first end; and transferring at least a portion of power from the power limited USB power source to the streaming media player via the power cable.

Methods may include limiting current, by a current limiter, from the power limited USB power source to a supercapacitor of the power cable to thereby prevent damage to the power limited USB power source; and storing excess power with the supercapacitor. Methods may also include regulating voltage between the supercapacitor and the streaming media player. In embodiments, storing the excess power via the supercapacitor can occur in response to available power from the power limited USB power source exceeding power demand by the streaming media player.

Methods may also include releasing at least a portion of the excess power from the supercapacitor in response to power demand by the streaming media player exceeding available power from the power limited USB power source. Even still, methods may include electrically and mechanically coupling a first end of an HDMI cable to the streaming media player, and electrically and mechanically coupling a second end of the HDMI cable to the television. As well, methods may include mounting the streaming media player to a backside of the television via a mounting device.

In embodiments, the power cable can be a first power cable, the streaming media player can be a first streaming media player, and the power limited USB power source can be a first power limited USB power source. Methods can include electrically and mechanically coupling a first end of a second power cable to a second power limited USB power source located on the television; electrically and mechanically coupling a second end of the second power cable to a second streaming media player, wherein the second end is opposite the first end; and transferring at least a portion of power from the second power limited USB power source to the second streaming media player via the second power cable.

The embodiments described above include many optional features and aspects. Features and aspects of the embodiments can be combined.

### BRIEF DESCRIPTION OF THE DRAWINGS

These and other features, aspects, and advantages are described below with reference to the drawings, which are intended to illustrate, but not to limit, the invention. In the drawings, like reference characters denote corresponding features consistently throughout similar embodiments.

FIG. 1 illustrates USB source power versus streaming media player load capability, according to some embodiments.

FIG. 2 illustrates USB source power versus streaming media player load capability, according to some embodiments.

FIG. 3 illustrates USB source power versus streaming media player load capability, according to some embodiments.

FIGS. 4a and 4b illustrate a power cable, according to some embodiments.

FIG. 5 illustrates an exploded view of a power cable, according to some embodiments.

FIG. 6 illustrates a schematic of a power cable, according to some embodiments.

FIG. 7 illustrates a block diagram of power flow from a USB power source to a streaming media player, according to some embodiments.

FIG. 8 illustrates a schematic of a printed circuit board, according to some embodiments.

FIG. 9 illustrates a power system, according to some embodiments.

FIG. 10 illustrates another power system, according to some embodiments.

FIG. 11 illustrates a kit, according to some embodiments.

FIG. 12 illustrates another kit, according to some embodiments.

FIG. 13 illustrates yet another kit, according to some embodiments.

FIG. 14 illustrates a flow chart of a method of using a power system, according to some embodiments.

FIG. 15 illustrates another flow chart of a method of using a power system, according to some embodiments.

### DETAILED DESCRIPTION

Although certain embodiments and examples are disclosed below, inventive subject matter extends beyond the specifically disclosed embodiments to other alternative embodiments and/or uses, and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components.

For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

### REFERENCE NUMERALS

2: power system
10: power cable
12: energy storage device or supercapacitor
14: housing
16: printed circuit board (e.g. printed circuit board with special current limiting and regulation circuitry, power averaging circuitry integrated into printed circuit board)
18: first connector
19: first end
20: second connector
21: second end
30: USB power source (e.g. a power limited USB power source of a television)
32: current limiter
36: voltage regulator
37: power input
38: power load
40: streaming media player
41: regulation circuit
42: circuit input
44: circuit output
50: load switch integrated circuit (“IC”)
52: first capacitor
54: second capacitor
56: first resistor
70: voltage regulator
74: third capacitor
76: fourth capacitor
78: inductor
94: fifth capacitor
96: first output resistor
98: second output resistor
110: kit
112: television
114: streaming media player mounting device
120: HDMI cable
140: second device
164: first connector housing
166: second connector housing
200: first side
202: second side
204: third side
206: fourth side
208: fifth side
210: sixth side
212: seventh side
214: eighth side
216: ninth side
218: tenth side
220: eleventh side
222: twelfth side
240: wall outlet

### INTRODUCTION

Cloud based streaming media players are becoming increasingly common as people transition away from legacy media delivery sources such as cable or satellite. Each new generation of streaming media player adds to the state of the art with new features and better performance than the previous generation. However, the techniques employed to power these new devices have not evolved as rapidly and have remained relatively simple. The two techniques employed today are simple AC/DC converters or direct Universal Serial Bus (“USB”) port connections.

While some lower end streaming media players (usually the HDMI stick-type) have an option to be powered from a USB port, most mainstream streaming media players are powered using an AC/DC converter attached to an AC wall outlet found near a television. Accordingly, it should be appreciated that this disclosure may refer to two different kinds of streaming media players: 1) stick-type streaming media players and 2) box-type streaming media players. Stick-type streaming media players can include a male HDMI connection that connects directly into a female HDMI port on a television, without using a cable (e.g. Google Chromecast™, Roku® Streaming Stick™, and the like). Box-type streaming media players, on the other hand, can include a female HDMI connection that connects to the female HDMI port of the television via a cable having male HDMI connections on each end (e.g. Apple TV®, Roku® 3, Roku® 2, Roku® 1, and the like). As well, a further differentiating characteristic is that box-type streaming media players can be somewhat larger than stick-type streaming media players. For example, the Apple TV® can weigh about 8.9 ounces, while the Google Chromecast™ can weigh only 1.1 ounces.

With reference to using the AC/DC converter versus the USB port connection to power the streaming media player, some users may not have an AC wall outlet located near the television and/or streaming media player. As well, using the AC wall outlet may not be ideal because users may already have other devices connected to the AC wall outlet or they may not want to run an additional cable from the AC outlet to the television since it can clutter the area around the television. Accordingly, a desirable solution may be to power the streaming media player with the USB port found on the television (e.g. power limited USB power source), thereby eliminating the need for an AC wall outlet.

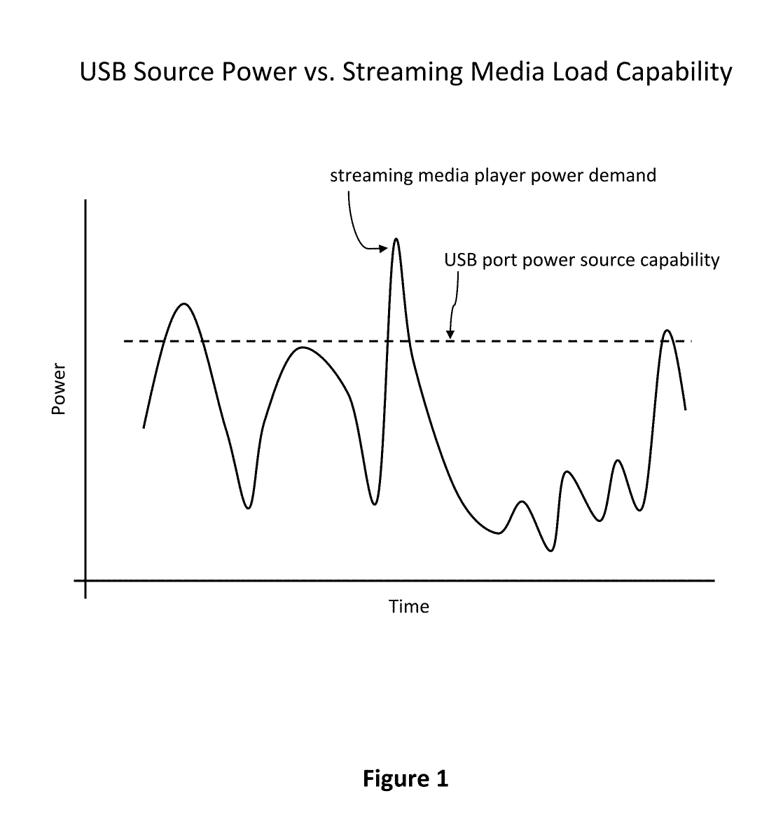

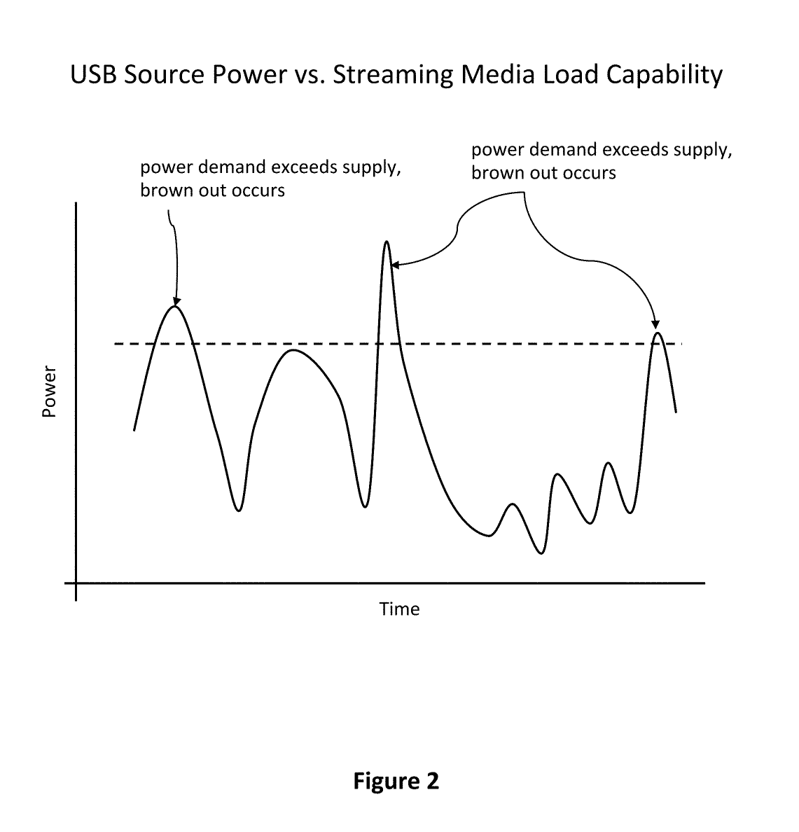

While ideal from a convenience standpoint, the USB-sourced power doesn't work well for most streaming media players. This is because the power consumption of the streaming media player can be variable and during periods of peak power consumption the available power from the USB port may not be sufficient, resulting in a brownout scenario in the streaming media player, as illustrated in FIGS. 1 and 2. Brownouts can negatively impact the quality of the user experience since they cause the streaming media player to shutdown prematurely.

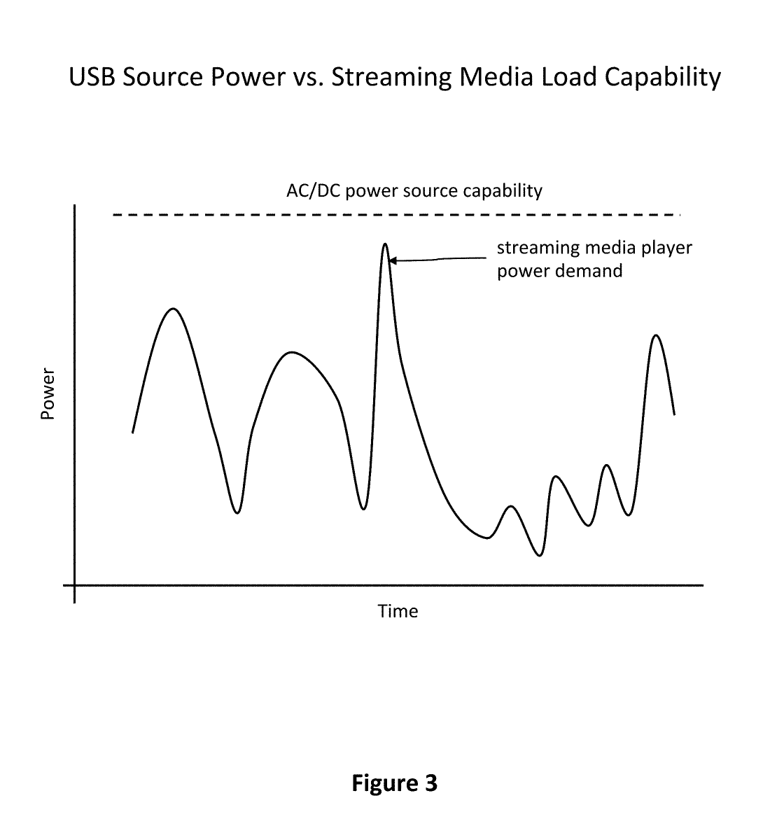

Complicating the situation is that television models have different USB power sourcing capabilities, usually varying between 2.5 watts to about 5 watts. Furthermore, the usage profile of streaming media players can vary from person to person (i.e. one user may use the device primarily for gaming while another only may want to view photos), which directly correlates to the power consumption profile of the streaming media player. For example, during operation the streaming media player can comprise a load circuit that requires input peak power greater than 2.5 watts, greater than 3 watts, greater than 4 watts, and even greater than 5 watts. Thus, the media power consumption profile and USB power source capability vary widely from setup to setup making it very difficult for the streaming media player manufacturer to guarantee a uniformly positive user experience when using USB ports as the power source. For this reason, and as illustrated in FIG. 3, most streaming media players are designed to be powered from AC wall outlets, which have uniformly sufficient power capability for all usage profiles.

### Power Cable Circuitry Embodiments

In order to create a USB power based power solution for devices (e.g. streaming media players) that provides sufficient power under all scenarios (i.e. weak USB power source and/or heavy power consumption periods) a power cable having electronic circuitry can be implemented into the overall entertainment system (e.g. television and streaming media player system). While streaming media players are used to illustrate many examples in this document, the invention is not limited to streaming media players. In embodiments, the power cable can be used with various devices including, but not limited to DVD players, game consoles (e.g. any XBOX® game console, any PlayStation® game console, any Wii® game console, and the like), stereo receivers, computers (e.g. laptops and desktops), remote computing devices (e.g. smart phones, tablets, etc.), and the like.

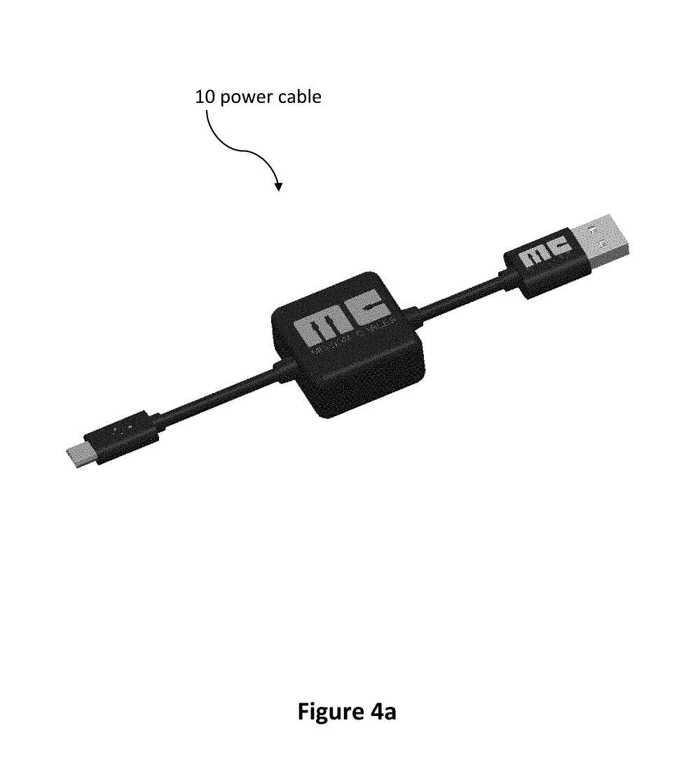

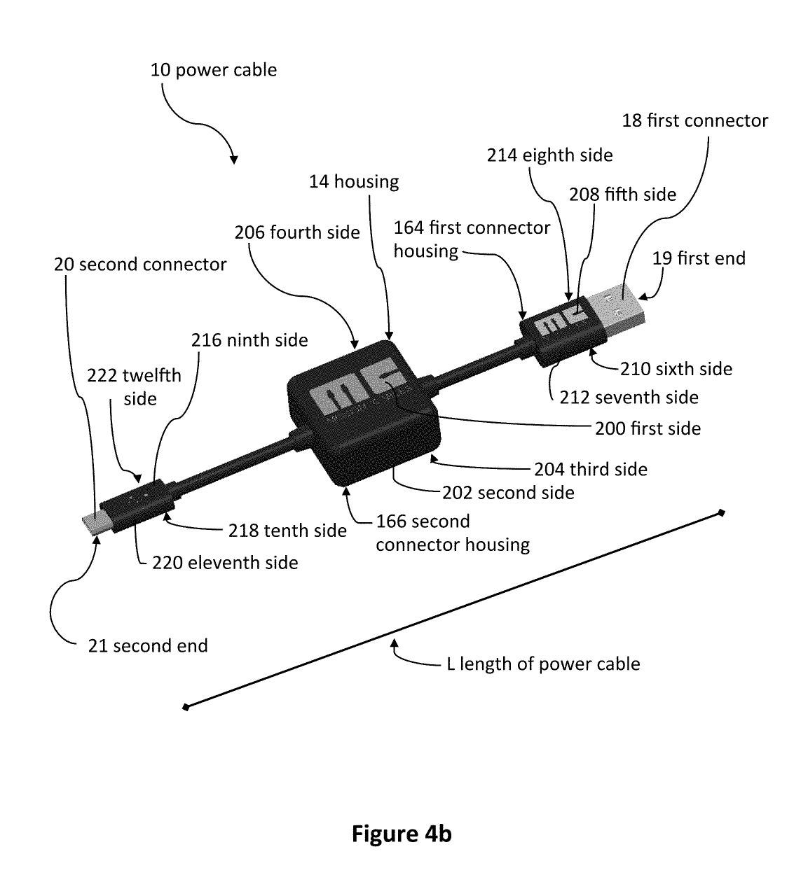

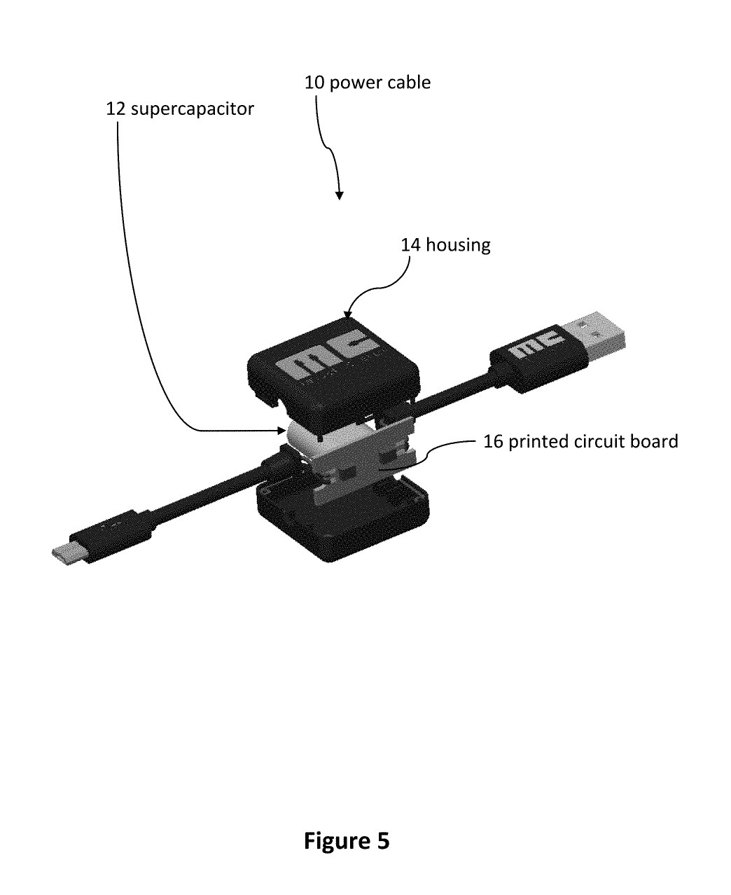

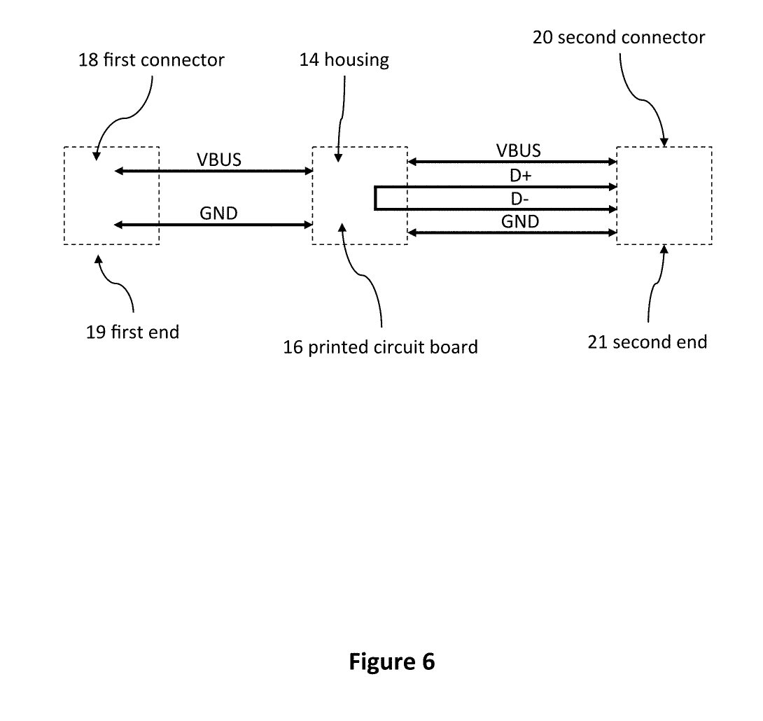

As illustrated in FIGS. 4a, 4b, 5, and 6, the power system 2 can include a power cable 10 with an integrated power-averaging scheme. In embodiments, the power cable 10 can comprise a first connector 18 at a first end 19 and a second connector 20 at a second end 21 that is opposite the first end 19.

As well, the cable 10 can include a housing 14 that can be located between the first connector 18 and the second connector 20. In some embodiments, the housing 14 comprises a printed circuit board 16 (“PCB”), which can include the power-averaging scheme that can utilize an energy reservoir and a regulation circuit 41.

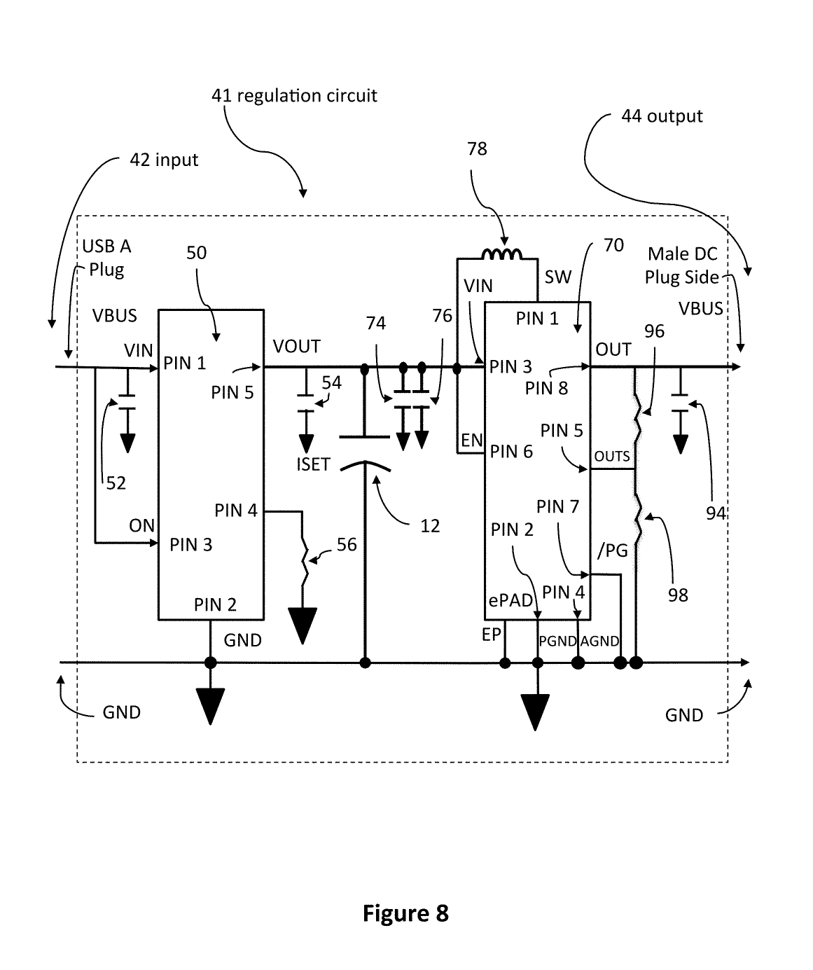

FIG. 8 illustrates a schematic design of the PCB 16 as utilized in some embodiments of the cable 10. The regulation circuit 41 can comprise an energy storage device 12 (e.g. a supercapacitor 12), current limiter 32, and an optional voltage regulator 36 that can include voltage regulation circuitry. A supercapacitor 12 is a high-capacity electrochemical capacitor that is capable of high capacitance values. Supercapacitors can store about 100 times more energy per unit volume than a standard electrolytic capacitor. As well, supercapacitors can have a much higher power density than batteries, meaning they can react quickly to changes in power load. Supercapacitors also can have a significantly longer life than batteries, making them an ideal energy storage device for load averaging applications such as powering streaming media players from a USB port.

Accordingly, the supercapacitor 12 and regulation circuitry can retain excess energy during periods of use when the power available from the USB port exceeds the power demanded by the streaming media player 40 and then releases the stored energy when the power demanded by the streaming media player 40 exceeds the source capability of the USB port, such as the power limited USB power source 30. In this regard, the average power load sensed by the USB port is maintained below its power source capability, thereby preventing a brownout scenario. This system of energy storage can be viable when the average power demand of the streaming media player 40 is lower than the average source power capability of the USB power source 30.

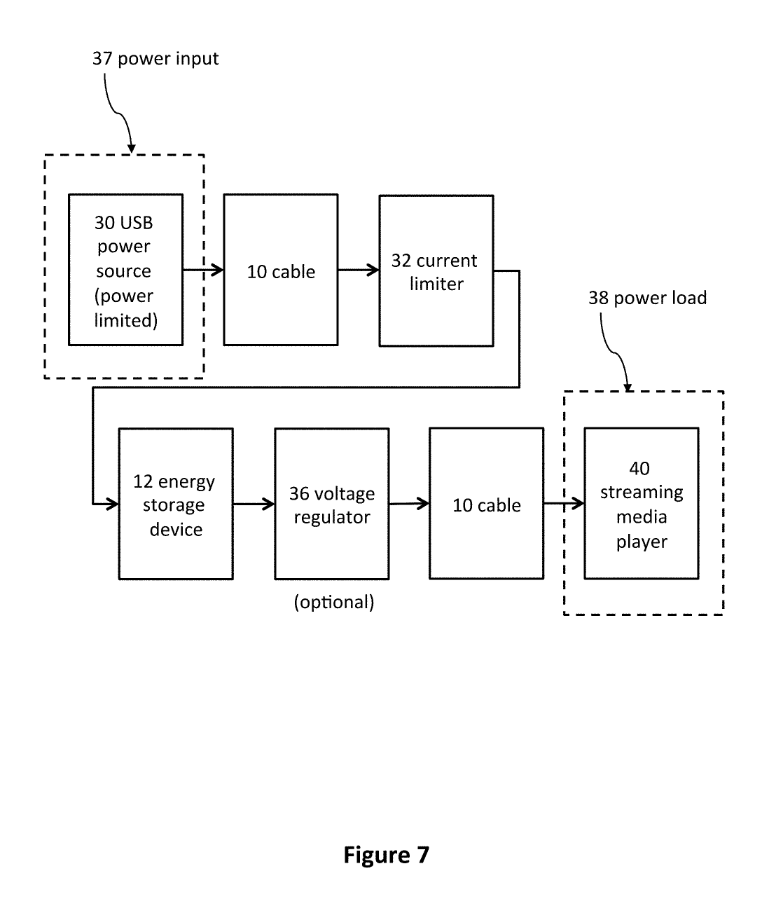

FIG. 7 illustrates a block diagram of the flow of energy from the USB power source 30 through the power cable 10 to the streaming media player 40. The USB power source 30 can be a USB connection that provides power input 37, and in some embodiments, the USB connection may provide communication. In some embodiments, the USB power source is a USB port on a television that can continuously provide power between 2.5 W and 5 W. The USB power source 30 can be coupled to the cable 10, which can transfer electrical power from one plate to another.

In embodiments, the USB power source 30 transfers electrical power to a downstream component, such as the current limiter 32. Accordingly, in such embodiments, the current limiter 32 can regulate (i.e. limit) the amount of current that charges the supercapacitor 12. In this regard, the current limiter 32 can limit the current to the supercapacitor 12, otherwise the in-rush current into the supercapacitor 12 could damage the USB power source 30. Accordingly, adding the current limiter 32 (i.e. the current limit circuit) can increase the initial charge time of the supercapacitor 12 while ensuring the peak input current is limited to a known, maximum value.

The supercapacitor 12 can be an energy storage device that can store and release energy on demand. Therefore, when available power from the USB power source 30 is greater than the streaming media player power demand, the supercapacitor 12 can thereby store energy. During times when the streaming media player power demand exceeds the available power from the USB power source 30, the supercapacitor 12 can thereby release energy to avoid a brownout of power load 38 (e.g. streaming media player 40). For example, in embodiments, the supercapacitor 12 can deliver at least 3 watts of power to the streaming media player 40 for a period of time when the USB power source is incapable of supplying sufficient power to the streaming media player 40. In embodiments, the period of time can comprise between 40 milliseconds and 2 seconds. In some embodiments, the period of time can comprise between 40 milliseconds and 5 seconds. Even still, in some embodiments, the period of time can comprise between 40 milliseconds and 10 seconds. Generally, it should be appreciated that the period of time can comprise any amount of time, from as little as 1 millisecond, 10 milliseconds, or 20 milliseconds all the way up to 1 second, 2 seconds, and even 20 seconds.

Furthermore, in some embodiments, the voltage of the supercapacitor 12 can vary (i.e. go up and down) over time depending on the input and output current. In these situations, the power cable 10 can include a voltage regulator 36, which can step up the voltage of the supercapacitor 12 to the voltage required to operate the streaming media player 40. An added benefit of the step-up voltage regulator 36 is that it can increase the discharge range of the supercapacitor 12, thereby increasing the supercapacitor's energy storage capability and thus reducing the capacitance required to support the peak power events in the system 2.

With reference to FIG. 8 and describing the circuit 41 in more detail, some embodiments of the circuit 41 can receive a current at input 42 from a USB source, such as a USB power source 30 of a television 112 (e.g. a power limited USB power source 30). The current can thereby be inputted into a load switch IC 50, which can be configured to regulate the incoming current such that the current does not exceed a predetermined maximum level as specified by first resistor 56 at pin 4 of the load switch IC 50. In some embodiments, the load switch IC 50 can be a Fairchild Semiconductor part no. FPF2125-SOT-25. As well, the first resistor 56 can be a 340 ohm+/−10% resistor. However, it should be appreciated that the first resistor 56 can be any size resistor capable of regulating the incoming current.

Once the current passes through load switch IC 50, the current can then pass to the supercapacitor 12 through pin 5 of the load switch IC 50, to thereby charge the current to a voltage level close to the USB source voltage. The USB source voltage can be any voltage within the range of 4.65 volts to 5.2 volts. The charge current can thereby decrease exponentially as the voltage increases. During the early stage of this charging event, the in-rush current into the supercapacitor 12 can be substantial which, without the current limiting function of the load switch IC 50, could damage the USB power source 30.

The supercapacitor 12 can convert a portion of the current to stored energy, which then is available to be released during intermittent power load spikes at output 44, such as power demand from a streaming media player 40, which exceed the power source capability of the USB power source 30. During periods of time that excess energy is being released, the voltage on the supercapacitor 12 can drop.

Alternatively, during periods when the available power at the USB power source 30 exceeds the power demanded by the load at output 44, such as the load from a streaming media player 40, there may be excess power available in the system. As such, the supercapacitor 12 can use a portion of the input current to replenish its stored energy and the voltage on the supercapacitor 12 will rise. In this regard, the supercapacitor 12 can perform an averaging function, ensuring that the total power delivered to the load at the output 44 never exceeds the available power at the input 42 of the system. In some embodiments, the supercapacitor 12 can be a 1.5 Farad supercapacitor, such as part no. EMHSR-0001C5-005R0 from Nesscap Co. Ltd. However, it should be appreciated that the supercapacitor 12 can be any size supercapacitor capable of performing the averaging function as previously described.

With continued reference to FIG. 8, the circuit 41 can optionally include a step-up voltage regulator 70, such as part no. MIC2875-AYMT TDFN from Micrel Inc. The voltage regulator 70 can be connected between the supercapacitor 12 and the load at the output 44 (e.g. the streaming media player load) to ensure that the voltage provided to the streaming media player 40, via output 44, is fixed and is of an appropriate voltage level. Current, at a low voltage, can be passed from the supercapacitor 12 to pin 1 of the voltage regulator 70, which is then upconverted to the desired voltage as set by first and second output resistors 96, 98. In some embodiments, the first output resistor 96 can be an 820 Kohm+/−1% R2 resistor. As well, in some embodiments, the second output resistor 98 can be a 150 Kohm+/−1% R3 resistor.

Current, at a higher voltage level, can then be sourced into the load at output 44 through pin 8 of the voltage regulator 70. This upconverting and voltage regulation function can be useful because the voltage at the supercapacitor 12 can vary as it performs its power averaging function, thereby making it incompatible with the input voltage requirements of some streaming media players. The step-up voltage regulator 70 also can have the added benefit of allowing the supercapacitor 12 to deliver more useful energy to the load by increasing the allowable supercapacitor 12 voltage discharge range, thereby maximizing the available power from the supercapacitor 12 and allowing the power averaging system to support higher power peaks over longer durations at the output 44.

The circuit 41 may be configured with various electrical components. Embodiments of the circuit 41 may include a first capacitor 52 electrically coupled between the input 42 and pin 1 of the load switch IC 50. In some embodiments, the first capacitor 52 comprises a 4.7 microfarad (“uF”) ceramic capacitor. As well, embodiments of the circuit 41 may include a second capacitor 54 electrically coupled between pin 5 (of the load switch IC 50) and the supercapacitor 12. In embodiments, the second capacitor 54 can be a 0.1 uF ceramic capacitor.

Even still, embodiments of the circuit 41 may include third and fourth capacitors 74, 76 electrically coupled between the supercapacitor 12 and pin 3 of the voltage regulator 70. In some embodiments, the third capacitor 74 comprises a C3 0805 capacitor and/or the fourth capacitor 76 comprises a 1 uF ceramic capacitor 6V C1. Embodiments of the circuit 41 may also include inductor 78 electrically coupled between the fourth capacitor 76 and pin 1 of the voltage regulator 70. In some embodiments, the fourth capacitor 76 comprises a Taiyo Yuden 1 microhenry (“uH”)—L1—NRS5020T1R0NMGJ. As well, embodiments of the circuit 41 may include a fifth capacitor 94 electrically coupled between pin 8 of the voltage regulator 70 and the output 44. In embodiments, the fifth capacitor 94 comprises a 22 uF (10V) X5R ceramic capacitor C2.

Furthermore, the circuit 41 may be configured to accommodate various loads from any type of streaming media player 40. For example, in some embodiments, circuit 41a may be arranged and configured to meet the specific load demands of some streaming media players, such as box-type streaming players. In this regard, the circuit 41a may include a supercapacitor that is greater than 1.5 Farads and the voltage regulator 70.

In other examples, circuit 41b may be arranged and configured according to reduced power demands (as compared to some box-type streaming players), such as the reduced power demands of stick-type streaming media players. In this regard, the circuit 41b may be include a supercapacitor that is less than 1.5 Farads. As well, the circuit 41b may be devoid of a voltage regulator 70.

### Power Cable Dimensional Embodiments

With reference to FIGS. 4a and 4b, the power cable 10 can comprise various types of connectors and define a length L and a variety of surfaces, or sides. For example, in some embodiments, the length L is less than or equal to 18 inches. However, in some embodiments, the length L is greater than to 18 inches. As well, the housing 14 of the power cable 10 can define a variety of shapes and sizes. In some embodiments, the housing 14 defines a rectangular shape having a first large side 200, a second large side 202 that is opposite the first large side 200, a third small side 204 that extends perpendicular to the first and second large sides 200 and 202, and a fourth small side 206 that is opposite the third small side 204.

With continued reference to FIGS. 4a and 4b, the first end 19 of the power cable 10 can include a first connector 18, such as USB type connector (e.g. a USB A—male connector, which can be coupled to a USB A—female connector on a television). For example, the USB A—male connector can comprise a first connector housing 164 that can define a rectangular shape having a fifth large side 208, a sixth large side 210 that is opposite the fifth large side 208, a seventh small side 210 that extends perpendicular to the fifth and sixth large sides 208 and 210, and an eighth small side 212 that is opposite the seventh small side 210.

As well, the second end 21 of the power cable 10 can include a second connector 20, such as a second USB type connector or a DC plug connector. For example, the second connector 20 can include a straight micro B—male, which can be coupled to a corresponding micro B female port of a streaming media player 40. While the second connector 20 can be a different type of connector than the first connector 18, it should also be appreciated that the second connector 20 can be the same type of connector as the first connector 18. In embodiments, the straight micro B—male connector can comprise a second connector housing 166 that can define a rectangular shape having a ninth large side 216, a tenth large side 218 that is opposite the ninth large side 216, a eleventh small side 220 that extends perpendicular to the ninth and tenth large sides 216 and 218, and an twelfth small side 222 that is opposite the eleventh small side 220.

In some embodiments, the first and second sides 200 and 202 are larger than the third side 204, fourth side 206, fifth side 208, sixth side 210, seventh side 212, eighth side 214, ninth side 216, tenth side 218, eleventh side 220, and twelfth side 222. As well, in some embodiments, the third and fourth sides 204 and 206 are larger than the fifth side 208, sixth side 210, seventh side 212, eighth side 214, ninth side 216, tenth side 218, eleventh side 220, and twelfth side 222.

Still referring to FIGS. 4a and 4b, in some embodiments, the fifth and sixth sides 208 and 210 are larger than the seventh side 212, eighth side 214, ninth side 216, tenth side 218, eleventh side 220, and twelfth side 222. Yet, in some embodiments, the seventh and eighth sides 212 and 214 are larger than the ninth side 216, tenth side 218, eleventh side 220, and twelfth side 222. Furthermore, in some embodiments, the ninth and tenth sides 216 and 218 are larger than the eleventh side 220 and twelfth side 220.

### Embodiments Having Additional Electronic Devices

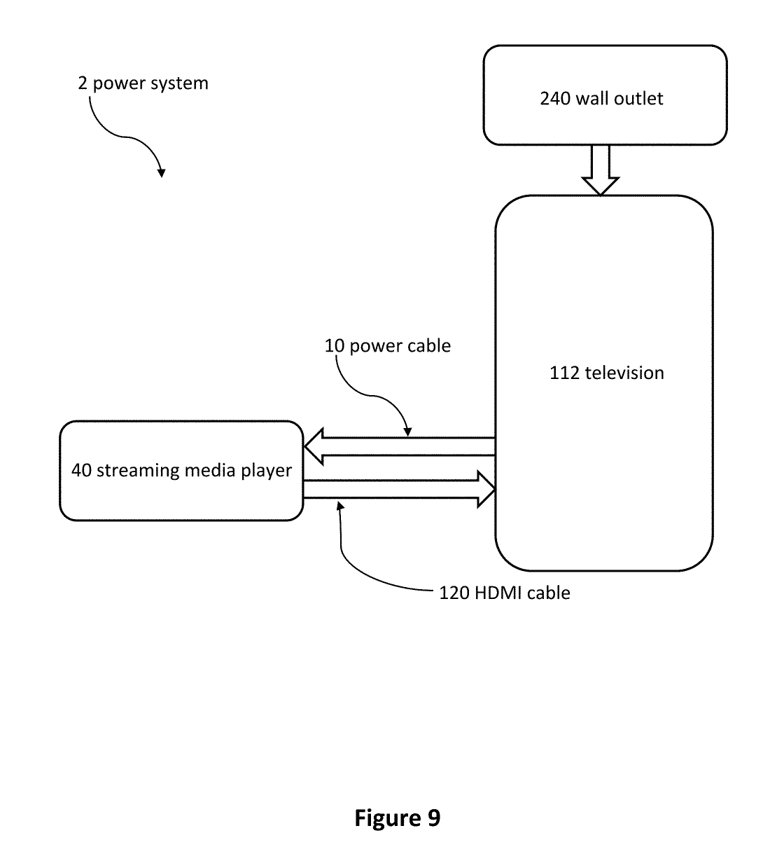

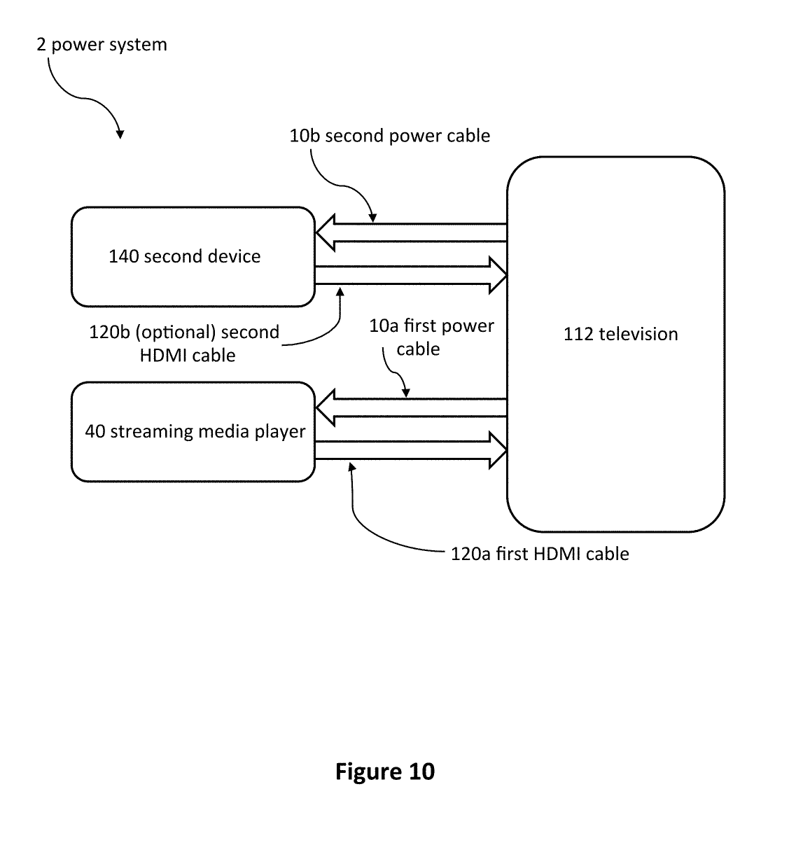

As shown in FIGS. 9 and 10, a power system 2 can include additional cables, such as High-Definition Multimedia Interface (“HDMI”), configured to transfer digital content from the streaming media player 40 to the television 112. As well, some embodiments of the power system 2 can include multiple power cables 10, such as first and second power cables 10a and 10b. In this regard, the power system 2 can be configured to include the streaming media player 40 and a second device 140. Accordingly, the streaming media player 40 and the second device 140 both can be powered by the television 112. Accordingly, it should be appreciated that the second device 140 can comprise a second device, such as a streaming media player, game console, DVD player, game console, stereo receiver, computer (e.g. laptop and desktop), remote computing device (e.g. smart phone, tablet, etc.), and the like. It should also be appreciated that the second device 140 can be mechanically and electrically coupled to the television 112.

### Kit Embodiments

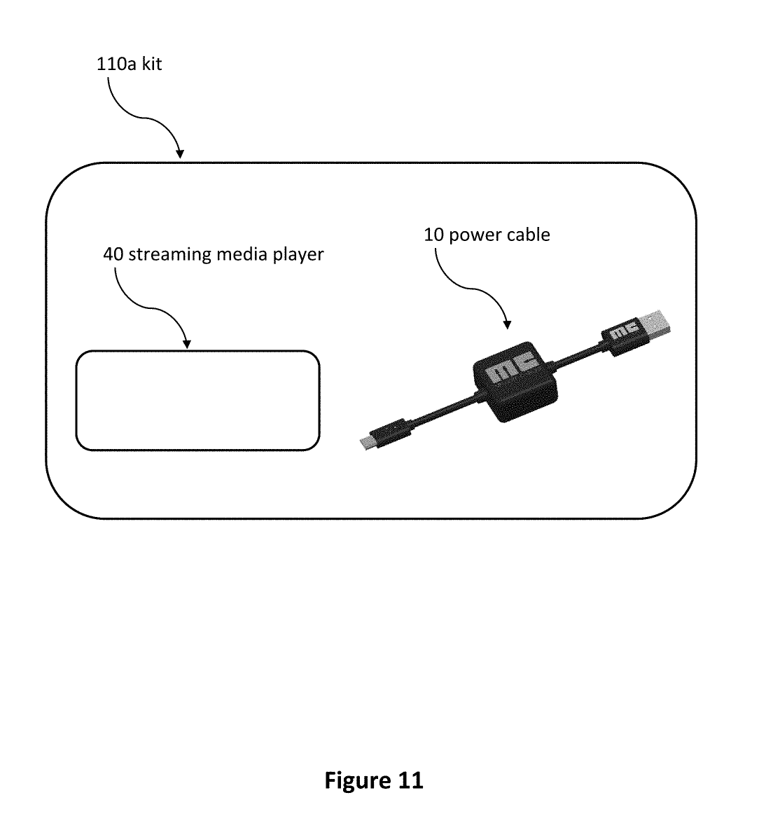

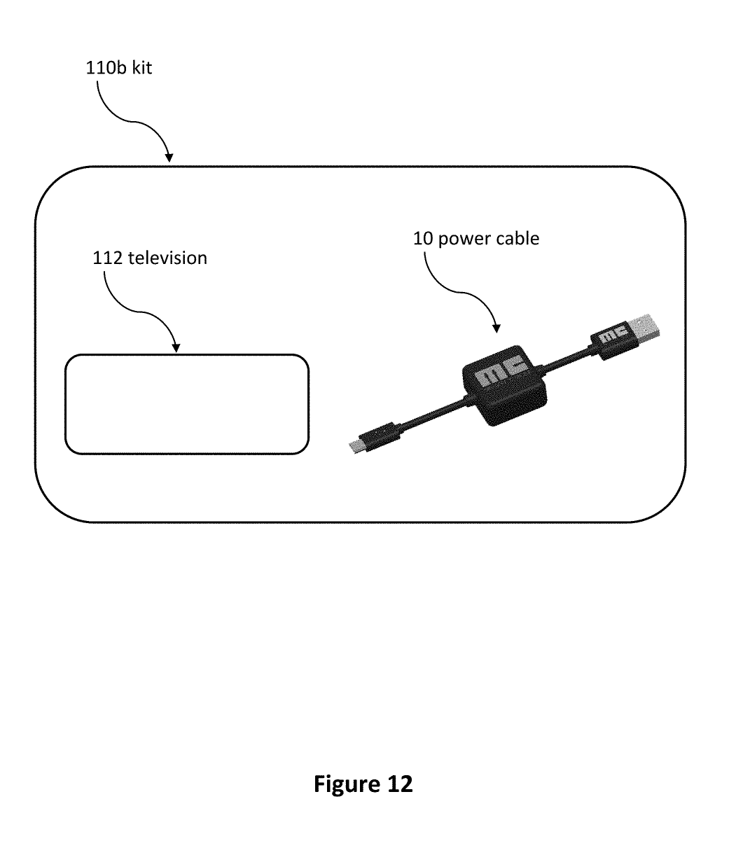

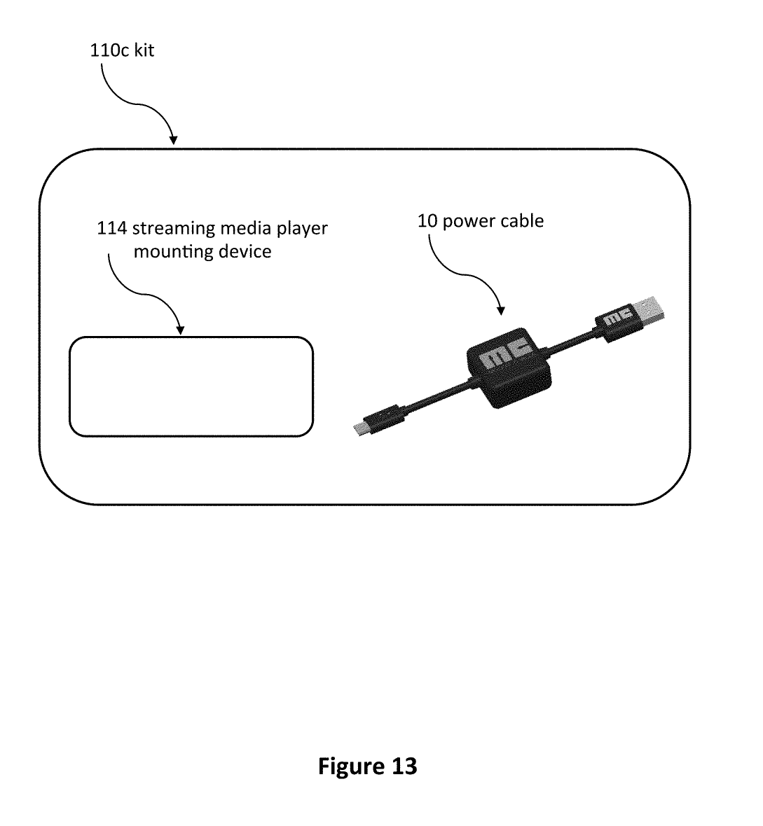

As illustrated in FIGS. 11-13, some embodiments of the power system may be kitted with other various devices. For example, in some embodiments, a kit 110a may include a power system, such as the cable 10, and a streaming media player 40. In some embodiments, a kit 110b may include a cable 10 and a television 112. Even still, in some some embodiments, a kit 110c may include a power cable 10 and a streaming media player mounting device 114, such as a mounting device disclosed in U.S. patent application Ser. No. 14/527,687, filed Oct. 29, 2014, and entitled MOUNTING SYSTEMS FOR DIGITAL MEDIA PLAYERS. The entire contents of U.S. patent application Ser. No. 14/527,687 are incorporated by reference herein. Generally, it should be appreciated that the cable 10 may be kitted with any electronic device that may be used during a streaming media player experience.

### Method Embodiments

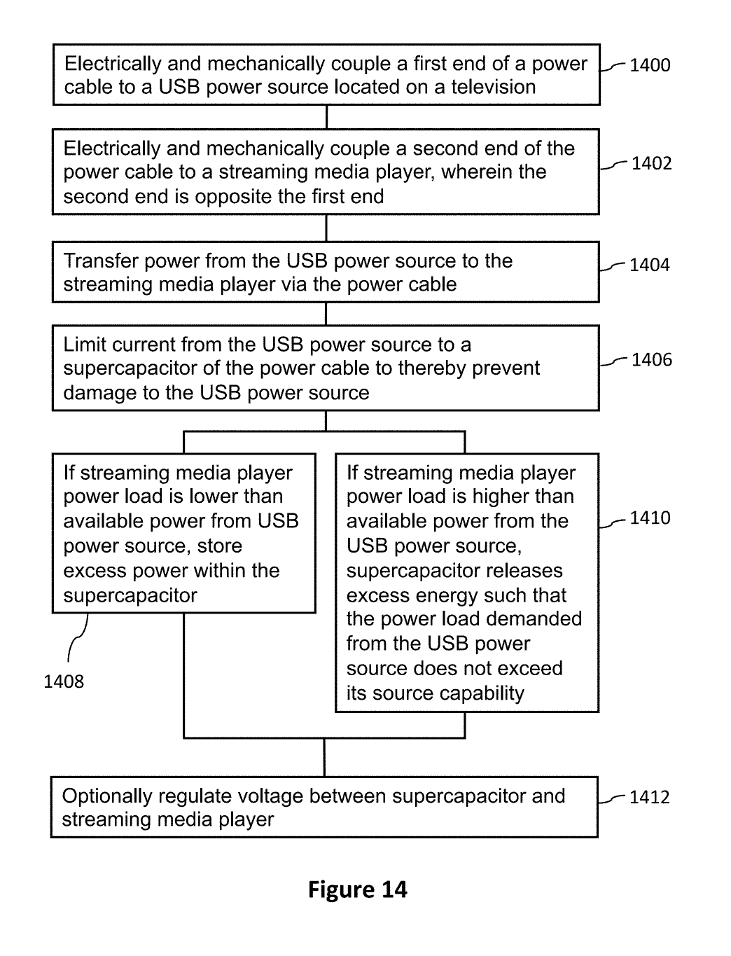

The cable 10 may also be used in various method embodiments, such as methods of providing power from a television to an electronic device, such as a streaming media player 40. As illustrated in FIG. 14, methods may include electrically and mechanically coupling a first end 150 of a power cable 10 to a USB power source 30 located on a television 112 (at step 1400), such as a backside or side of a television 112. Methods may also include electrically and mechanically coupling a second end 152 of the power cable 10 to a streaming media player 40, wherein the second end 152 is opposite the first end 150 (at step 1402).

In some embodiments, methods may include transferring power from the USB power source 30 to the streaming media player 40 via the power cable 10 (at step 1404). As well, methods also may include limiting current from the USB power source 30 to a supercapacitor 12 of the power cable 10 to thereby prevent damage to the USB power source 30 (at step 1406).

If the streaming media player power load is lower than the available power from the USB power source 30, methods may include storing excess power within the supercapacitor 12 (at step 1408). Alternatively, if the streaming media player power load is higher than the available power from the USB power source 30, then the supercapacitor 12 may release at least a portion of the excess energy such that the power load demanded from the USB power source 30 does not exceed its source capability (at step 1410). As well, some embodiments may include regulating voltage between the supercapacitor 12 and the streaming media player 40 (at step 1412).

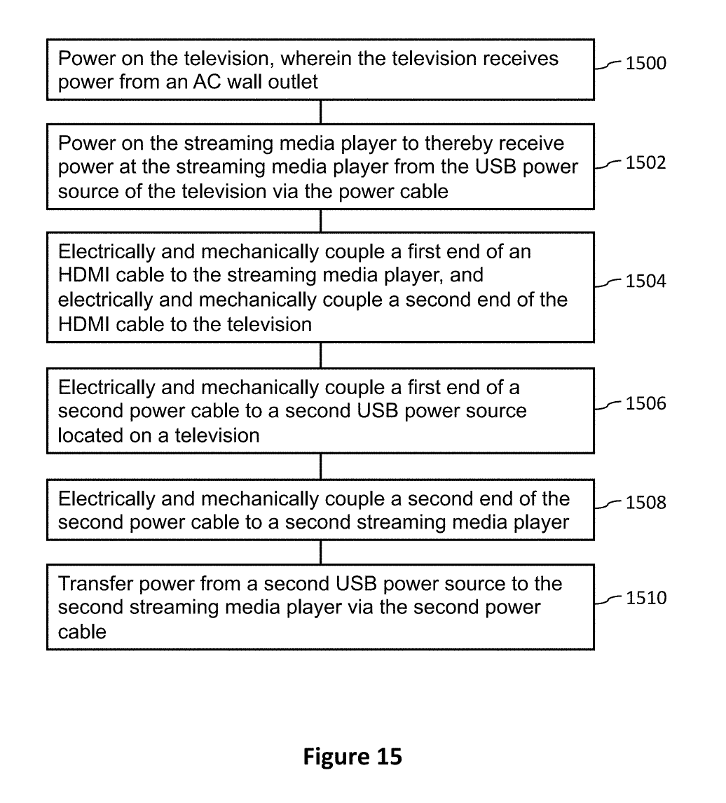

As illustrated in FIG. 15, methods may further include powering on the television 112, wherein the television 112 receives power from an AC wall outlet 240 (at step 1500). Methods may also include powering on the streaming media player 40 to thereby receive power at the streaming media player 40 from the USB power source 30 of the television 112 via the power cable 10 (at step 1502). Furthermore, methods may include electrically and mechanically coupling a first end of an HDMI cable 120 to the streaming media player 40, and electrically and mechanically coupling a second end of the HDMI cable 120 to the television 112 (at step 1504).

Some methods may also include powering a second device, or powering an altogether different device than a streaming media player, such as a game console, DVD player, or any electronic device previously disclosed in this document. For example, some methods may include electrically and mechanically coupling a first end of a second power cable 10b to a second USB power source 30b located on a television 112 (at step 1506), such as a backside or a side of a television 112.

As well, methods may include electrically and mechanically coupling a second end of the second power cable 10b to a second streaming media player 40b, wherein the second end is opposite the first end (at step 1508). Furthermore, methods may include transferring power from the second USB power source 30b to the second streaming media player 40b via the second power cable 10b (at step 1510).

Furthermore, to view content from the streaming media player 40 on the television 112, methods may optionally include electrically and mechanically coupling a first end of an HDMI cable to the streaming media player 40. Accordingly, methods may also include electrically and mechanically coupling a second end of the HDMI cable to the television 112 to thereby facilitate transfer of the digital signal from the streaming media player 40 to the television 112.

Box-type streaming media players 40 may be somewhat bulky, as compared to stick-type streaming media players. As well, unlike stick-type streaming media players, box-type streaming media players 40 may not be directly mechanically coupled to a respective port on the television 112, such as an HDMI port. Therefore, box-type streaming media players 40 may be mounted on or near the television 112, such as on an adjacent wall. Accordingly, methods may also include mounting the box-type streaming media player 40 to the backside of the television 112 via a mounting device 114.

### Interpretation

The term “television” can be referred to as TV, tv, and the like. The term “streaming media player” can be referred to as media player, streaming player, digital media player, digital media extender, and the like. As well, the term “remote control” can be referred to as remote, remote control device, and the like. In regards to the term “streaming media player remote control,” this term can be referred to as Bluetooth remote, Bluetooth remote control, streaming media player remote, and the like.

None of the steps described herein is essential or indispensable. Any of the steps can be adjusted or modified. Other or additional steps can be used. Any portion of any of the steps, processes, structures, and/or devices disclosed or illustrated in one embodiment, flowchart, or example in this specification can be combined or used with or instead of any other portion of any of the steps, processes, structures, and/or devices disclosed or illustrated in a different embodiment, flowchart, or example. The embodiments and examples provided herein are not intended to be discrete and separate from each other.

The section headings and subheadings provided herein are nonlimiting. The section headings and subheadings do not represent or limit the full scope of the embodiments described in the sections to which the headings and subheadings pertain. For example, a section titled “Topic 1” may include embodiments that do not pertain to Topic 1 and embodiments described in other sections may apply to and be combined with embodiments described within the “Topic 1” section.

Some of the devices, systems, embodiments, and processes use computers. Each of the routines, processes, methods, and algorithms described in the preceding sections may be embodied in, and fully or partially automated by, code modules executed by one or more computers, computer processors, or machines configured to execute computer instructions. The code modules may be stored on any type of non-transitory computer-readable storage medium or tangible computer storage device, such as hard drives, solid state memory, flash memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and subcombinations are intended to fall within the scope of this disclosure. In addition, certain method, event, state, or process blocks may be omitted in some implementations. The methods, steps, and processes described herein are also not limited to any particular sequence, and the blocks, steps, or states relating thereto can be performed in other sequences that are appropriate. For example, described tasks or events may be performed in an order other than the order specifically disclosed. Multiple steps may be combined in a single block or state. The example tasks or events may be performed in serial, in parallel, or in some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

The term “and/or” means that “and” applies to some embodiments and “or” applies to some embodiments. Thus, A, B, and/or C can be replaced with A, B, and C written in one sentence and A, B, or C written in another sentence. A, B, and/or C means that some embodiments can include A and B, some embodiments can include A and C, some embodiments can include B and C, some embodiments can only include A, some embodiments can include only B, some embodiments can include only C, and some embodiments can include A, B, and C. The term “and/or” is used to avoid unnecessary redundancy.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein.

The following is claimed:

1. A power system for a streaming media player defining a power load, wherein the streaming media player connects to a Wi-Fi network to stream digital media content to a television, comprising:
a cable having a first end and a second end opposite the first end, wherein the first end is configured to receive power from a USB power source on the television; and
an electronic circuit electrically coupled to the cable, wherein the electronic circuit is configured to provide real-time power averaging between the power source and the power load, and the electronic circuit comprises:
a current limiting integrated circuit;
a resistor electrically coupled in parallel to the current limiting integrated circuit;
a supercapacitor electrically coupled in parallel to the current limiting integrated circuit;
a capacitor electrically coupled in parallel between at least one of the first end of the cable and the current limiting integrated circuit, the supercapacitor and the current limiting integrated circuit, and the supercapacitor and the second end of the cable; and
a ground connection that electrically grounds the current limiting integrated circuit, the resistor, the supercapacitor, and the capacitor, and wherein the second end of the cable is configured to transfer power from the supercapacitor to the streaming media player.

2. The power system of claim 1, wherein the electronic circuit comprises a switching type voltage regulator integrated circuit electrically coupled in parallel to the super capacitor, wherein the switching type regulator integrated circuit includes an electrically coupled inductor, and a ground connection that electrically grounds the switching type voltage regulator integrated circuit.

3. The power system of claim 1, further comprising the USB power source located on the television, wherein the first end of the cable is electrically and mechanically coupled to the USB power source.

4. The power system of claim 3, further comprising the streaming media player, wherein the second end of the cable is electrically and mechanically coupled to the streaming media player.

5. The power system of claim 4, wherein the streaming media player comprises a stick-type streaming media player.

6. The power system of claim 4, wherein the streaming media player comprises a box-type streaming media player.

7. The power system of claim 1, wherein the streaming media player requires input peak power greater than 3 watts during operation.

8. The power system of claim 7, wherein the supercapacitor delivers at least 3 watts power to the streaming media player for a period of time when the USB power source is incapable of supplying sufficient power to the streaming media player.

9. The power system of claim 8, wherein the period of time comprises between 40 milliseconds and 5 seconds.

10. The power system of claim 1, wherein the first end of the cable comprises a first USB type connector and the second end of the cable comprises one of a second USB type connector and a DC plug connector.

11. The power system of claim 1, wherein the cable defines a length less than or equal to 10 inches.

12. The power system of claim 1, further comprising a plastic housing having an internal space.

13. The power system of claim 12, wherein the electronic circuit electrically is located along the internal space of the plastic housing.

14. A method of providing power to a streaming media player defining a power load, wherein the streaming media player connects to a Wi-Fi network to stream digital media content to a television, comprising:
electrically and mechanically coupling a first end of a power cable to a USB power source on the television, wherein the power cable comprises an electronic circuit configured to provide real-time power averaging between the USB power source and the power load, wherein the electronic circuit comprises a current limiting integrated circuit, a resistor electrically coupled in parallel to the current limiting integrated circuit, a supercapacitor electrically coupled in parallel to the current limiting integrated circuit, a capacitor electrically coupled in parallel between at least one of the first end of the power cable and the current limiting integrated circuit, the supercapacitor and the current limiting integrated circuit, and the supercapacitor and the second end of the power cable, and a ground connection that electrically grounds the current limiting integrated circuit, the resistor, the supercapacitor, and the capacitor;
electrically and mechanically coupling a second end of the power cable to the streaming media player; and
providing, via the electronic circuit, real-time power averaging between the power source and the power load.

15. The method of claim 14, further comprising:
limiting current, by the current limiting integrated circuit, from the USB power source to the supercapacitor to thereby prevent damage to the USB power source; and
storing excess power with the supercapacitor.

16. The method of claim 15, further comprising regulating voltage between the supercapacitor and the streaming media player.

17. The method of claim 15, wherein storing the excess power via the supercapacitor occurs in response to available power from the USB power source exceeding power demand by the streaming media player.

18. The method of claim 15, further comprising releasing at least a portion of the excess power from the supercapacitor in response to power demand by the streaming media player exceeding available power from the USB power source.

19. The method of claim 18, wherein the streaming media player comprises a stick-type streaming media player.

20. The method of claim 18, wherein the streaming media player comprises a box-type streaming media player.
